(19) United States
(12) Patent Application Publication
(10) Pub. No.: US 2017/0184520 A1
(43) Pub. Date: Jun. 29, 2017

(54) X-Ray Spectrometer with Source Entrance Slit

(71) Applicant: University of Washington, Seattle, WA (US)

(72) Inventors: Devon R. Mortensen, Seattle, WA (US); Gerald Todd Seidler, Seattle, WA (US)

(21) Appl. No.: 15/392,430

(22) Filed: Dec. 28, 2016

Related U.S. Application Data
(60) Provisional application No. 62/271,989, filed on Dec. 28, 2015.

(51) Int. Cl. G01N 23/20

(52) U.S. Cl. CPC G01N 23/20091; G01N 23/20008

(57) ABSTRACT

An example spectrometer includes a crystal analyzer having a radius of curvature that defines a Rowland circle and a sample stage configured to support a sample such that the sample is offset from the Rowland circle. The spectrometer further includes an x-ray source aligned to emit x-rays toward the sample and an entrance slit formed within a material that is opaque to x-rays. The entrance slit is fixedly coupled to the x-ray source such that the entrance slit defines a range of angles at which x-rays that are emitted by the sample and pass through the entrance slit are incident on the crystal analyzer. The spectrometer further includes a position-insensitive x-ray detector aligned to detect x-rays that are scattered by the crystal analyzer.

### CROSS-REFERENCE TO RELATED APPLICATION

This application claims the benefit of U.S. Provisional Patent Application No. 62/271,989, filed on Dec. 28, 2015, the contents of which are incorporated herein by reference in their entirety.

### STATEMENT REGARDING FEDERALLY SPONSORED RESEARCH OR DEVELOPMENT

This invention was made with government support under Contract Numbers DE-FG02-09ER16106 and DE-SC0008580, awarded by the Department of Energy. The government has certain rights in the invention.

### BACKGROUND

Unless otherwise indicated herein, the materials described in this section are not prior art to the claims in this application and are not admitted to be prior art by inclusion in this section.

Many x-ray spectrometers operate by illuminating a material sample with a broadband spectrum of x-rays and detecting the intensity of x-rays emitted by the sample. The same instruments can also often be used to interrogate x-ray intensities transmitted through the sample, either before or after monochromatization of the broadband spectrum by a suitable method. Finally, the instruments can sometimes also be used to detect the x-ray absorption characteristics of the sample from a monochromatized beam by observing the fluorescence stimulated only by the monochromatized beam. Typically, a detector “counts” x-rays that are received over a given period of time respectively for many discrete energy levels or ranges of x-rays. Since the detector generally is not able to directly distinguish between x-rays of different energy levels, a monochromator such as a crystal analyzer can be used to generate a separate count or intensity for each discrete energy level or range of x-rays. The crystal analyzer can be aligned to receive x-rays directly from the broadband x-ray source to generate a monochromatic beam or to receive x-rays emitted from the sample or transmitted through the sample. At any given angle of incidence, the crystal analyzer will generally only scatter x-rays within a particular energy range due to Bragg's law, subject to harmonics. As such, by controlling the angle at which x-rays are incident on the crystal analyzer, one can limit the x-rays being scattered toward the detector to be within a particular energy range. The angle of incidence can be changed in a controlled manner to select x-rays of varying energy. This may be referred to as a “source constrained” approach.

One way to constrain the angles at which x-rays become incident on the crystal analyzer is to illuminate the sample with a focused x-ray beam having a small beam spot on the sample. This can be accomplished via a synchrotron source or focusing optics, but this adds cost and complexity.

The energies of x-rays reaching the detector can also be limited using a “detector constrained” approach. This may involve using a position-sensitive detector that is able to distinguish and identify x-rays having different energies based on the different reflection angles from the crystal analyzer and consequent different positions at which they arrive at the detector. Another approach involves using an entrance slit that limits the angles at which x-rays coming from the crystal analyzer may be visible to the detector. These options add cost, complexity, or inefficiency as well.

### SUMMARY

In one example, a spectrometer includes a crystal analyzer having a radius of curvature that defines a Rowland circle and a sample stage configured to support a sample such that the sample is offset from the Rowland circle. The spectrometer further includes an x-ray source aligned to emit x-rays toward the sample and an entrance slit formed within a material that is opaque to x-rays. The entrance slit is fixedly coupled to the x-ray source such that the entrance slit defines a range of angles at which x-rays that are emitted by the sample and pass through the entrance slit are incident on the crystal analyzer. The spectrometer further includes a position-insensitive x-ray detector aligned to detect x-rays that are scattered by the crystal analyzer.

In another example, a spectrometer includes a crystal analyzer having a radius of curvature that defines a Rowland circle and an entrance slit formed within a material that is opaque to x-rays. The material is configured to support a sample and the entrance slit defines a range of angles at which x-rays that pass through the sample and the entrance slit are incident on the crystal analyzer. The spectrometer further includes an x-ray source aligned to emit x-rays toward the sample and the entrance slit. The entrance slit is fixedly coupled to the x-ray source. The spectrometer further includes a position-insensitive x-ray detector aligned to detect x-rays that are scattered by the crystal analyzer.

In yet another example, a spectrometer includes a crystal analyzer having a radius of curvature that defines a Rowland circle and an entrance slit formed within a material that is opaque to x-rays. The entrance slit defines a range of angles at which x-rays that pass through the entrance slit are incident on the crystal analyzer. The spectrometer further includes an x-ray source aligned to emit x-rays toward the entrance slit. The entrance slit is fixedly coupled to the x-ray source. The spectrometer further includes a position-insensitive x-ray detector aligned to detect x-rays that are scattered by the crystal analyzer and an exit slit formed within a material that is opaque to x-rays. The material that forms the exit slit is configured to support a sample. The exit slit defines a range of angles at which x-rays that are scattered by the crystal analyzer and transmitted through the sample are received by the position-insensitive x-ray detector.

In yet another example, a spectrometer includes a crystal analyzer having a radius of curvature that defines a Rowland circle and an entrance slit formed within a material that is opaque to x-rays. The entrance slit defines a range of angles at which x-rays that pass through the entrance slit are incident on the crystal analyzer. The spectrometer further includes an x-ray source aligned to emit x-rays toward the entrance slit. The entrance slit is fixedly coupled to the x-ray source. The spectrometer further includes a position-insensitive x-ray detector aligned to detect x-rays that are scattered by the crystal analyzer and emitted by the sample. The spectrometer further includes an exit slit formed within a material that is opaque to x-rays. The exit slit defines a range of angles at which x-rays that are scattered by the crystal analyzer are received by the sample.

In yet another example, a method is performed via a spectrometer having a Rowland circle geometry. The method includes exciting, via an x-ray source, a sample that is mounted on a sample stage such that the sample is offset from the Rowland Circle, thereby causing the sample to emit x-rays that travel through an entrance slit positioned between the sample and a crystal analyzer. The crystal analyzer has a radius of curvature that defines the Rowland circle and the entrance slit is fixedly coupled to the x-ray source. The method further includes scattering, via the crystal analyzer, the x-rays that are emitted by the sample and travel through the entrance slit. The method further includes detecting, via a position-insensitive x-ray detector, the x-rays that are scattered by the crystal analyzer.

In yet another example, a method is performed via a spectrometer having a Rowland circle geometry. The method includes emitting, via an x-ray source, x-rays that travel through a sample and an entrance slit positioned between the x-ray source and a crystal analyzer. The crystal analyzer has a radius of curvature that defines the Rowland circle and the entrance slit is fixedly coupled to the x-ray source. The method further includes scattering, via the crystal analyzer, the x-rays that are emitted by the x-ray source and travel through the sample and the entrance slit. The method further includes detecting, via a position-insensitive x-ray detector, the x-rays that are scattered by the crystal analyzer and travel through an exit slit that is positioned between the position-insensitive x-ray detector and the crystal analyzer.

In yet another example, a method is performed via a spectrometer having a Rowland circle geometry. The method includes emitting, via an x-ray source, x-rays that travel through an entrance slit positioned between the x-ray source and a crystal analyzer. The crystal analyzer has a radius of curvature that defines the Rowland circle and the entrance slit is fixedly coupled to the x-ray source. The method further includes scattering, via the crystal analyzer, the x-rays that are emitted by the x-ray source and travel through the entrance slit. The method further includes detecting, via a position-insensitive x-ray detector, the x-rays that are scattered by the crystal analyzer and travel through a sample and an exit slit that is positioned between the position-insensitive x-ray detector and the crystal analyzer.

In yet another example, a method is performed via a spectrometer having a Rowland circle geometry. The method includes emitting, via an x-ray source, x-rays that travel through an entrance slit positioned between the x-ray source and a crystal analyzer. The crystal analyzer has a radius of curvature that defines the Rowland circle and the entrance slit is fixedly coupled to the x-ray source. The method further includes scattering, via the crystal analyzer, the x-rays that are emitted by the x-ray source and travel through the entrance slit. The method further includes detecting, via a position-insensitive x-ray detector, the x-rays that are scattered by the crystal analyzer, travel through an exit slit that is positioned between the position-insensitive x-ray detector and the crystal analyzer, and are emitted by a sample.

When the term “substantially” or “about” is used herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. In some examples disclosed herein, “substantially” or “about” means within +/−5% of the recited value.

Various embodiments disclosed herein may be discussed in further detail in “Benchtop Nonresonant X-ray Emission Spectroscopy: Coming Soon to Laboratories and XAS Beamlines Near You?,” by Devon R. Mortensen, Gerald T. Seidler, Alexander S. Ditter and Pieter Glatzel, which is hereby incorporated by reference in its entirety (available at http://iopscience.iop.org/article/10.1088/1742-6596/712/1/012036/pdf).

These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 depicts a spectrometer, according to an example embodiment.

FIG. 2 depicts a spectrometer, according to an example embodiment.

FIG. 3 depicts a spectrometer, according to an example embodiment.

FIG. 4 depicts a spectrometer, according to an example embodiment.

FIG. 5 depicts a spectrometer, according to an example embodiment.

FIG. 6 depicts a spectrometer, according to an example embodiment.

FIG. 7 is a block diagram of a method, according to an example embodiment.

FIG. 8 is a block diagram of a method, according to an example embodiment.

FIG. 9 is a block diagram of a method, according to an example embodiment.

FIG. 10 is a block diagram of a method, according to an example embodiment.

### DETAILED DESCRIPTION

As discussed above, either “source constrained” or “detector constrained” configurations can be used to properly identify the energy levels of x-rays that are received by a detector. The following disclosure describes an additional “source constrained” approach.

For example, a spectrometer may be source constrained by an entrance slit that is placed between the sample and the crystal analyzer. The entrance slit may be fixedly coupled to an x-ray source such that the locations from which x-rays may be emitted from the sample toward the crystal analyzer are defined by the dimensions of the entrance slit, and not by the size or positioning of the sample. In the absence of the entrance slit, minor inconsistencies in sample size and in how different samples are placed in the spectrometer may cause energies of x-rays originating from the different samples to be incorrectly identified, due to the unintended change of angle range at which such x-rays could become incident upon the crystal analyzer. This approach yields the same effect as using a focused x-ray source with the illumination spot on the Rowland circle, however at a reduced cost and complexity. Constraining the angles at the source side in this way also allows the use of a position-insensitive x-ray detector, further reducing cost and complexity.

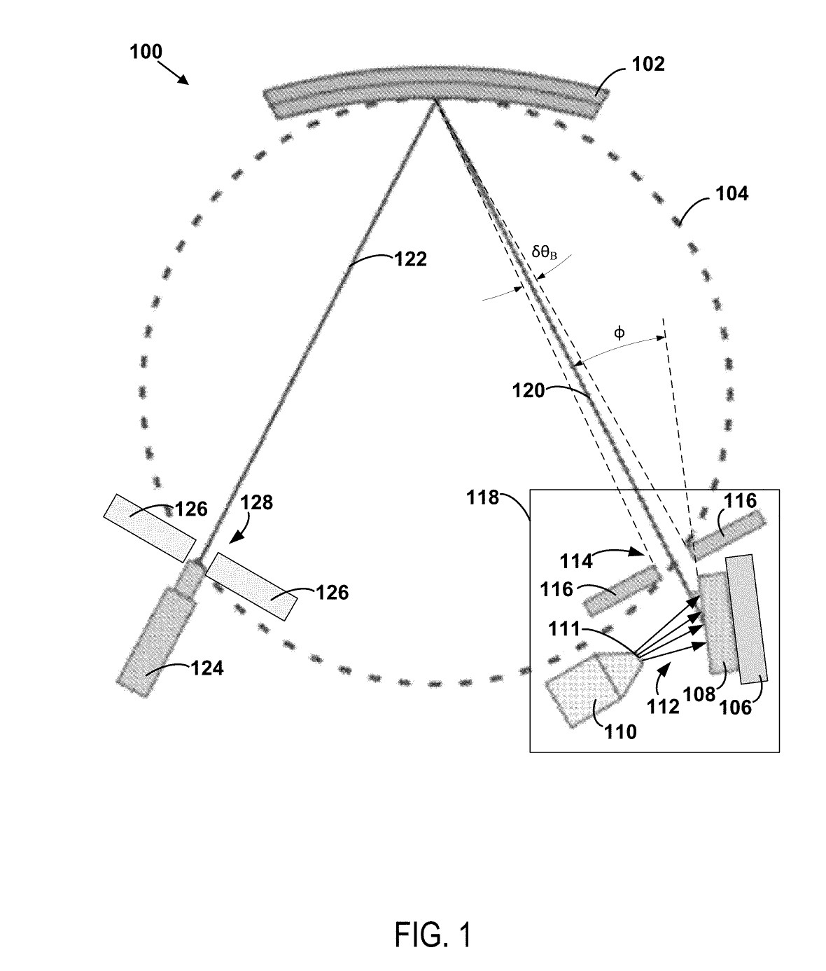

FIG. 1 depicts a spectrometer 100, a crystal analyzer 102, a Rowland circle 104, a sample stage 106, a sample 108, an x-ray source 110, x-rays 112, an entrance slit 114, a material 116, a structural element 118, x-rays 120, x-rays 122, and a detector 124.

The crystal analyzer 102 is composed of a crystalline material such as silicon or germanium, for example. The crystal analyzer 102 is configured to receive the x-rays 120 that are emitted by the sample 108 and may operate by selectively scattering, via Bragg reflection, x-rays within a particular wavelength/energy band based on the lattice spacing of the crystal analyzer 102 and the orientation of the crystal analyzer 102 with respect to the sample 108. The crystal analyzer 102 may have one or more of the following curvatures: spherical, toroidal, more complex double-curvature, or cylindrical each in, for example, a Johann variant, or a Johansson variant. The crystal analyzer 102 may have at least one axis of rotational symmetry.

As shown in FIG. 1, the crystal analyzer 102 may have a radius of curvature that defines the Rowland circle 104. The radius of curvature of the crystal analyzer 102 may be equal to the diameter of the Rowland circle 104 (i.e., twice the radius of the Rowland circle 104), but other examples are possible.

The sample stage 106 may include any structure or platform configured to hold or support the sample 108 such that the sample 108 is offset from (e.g., outside) the Rowland circle 104 as shown in FIG. 1. The sample stage 106 may be mounted to the structural element 118, but other examples are possible.

The sample 108 may generally include any liquid or solid material sample of interest. In the case of a liquid sample 108, the sample 108 may be enclosed within a transparent container and mounted on the sample stage 106. A solid sample 108 may be directly mounted on the sample stage 106.

The x-ray source 110 may take the form of an x-ray tube, but other examples are possible. The x-ray source 110 may be configured to emit x-rays 112 towards the sample 108. In an emission mode, the x-rays 112 impacting the sample 108 may cause the sample 108 to emit additional x-rays 120 toward the crystal analyzer 102. The x-rays 112 may include unfocused and/or broadband x-rays, but other examples are possible.

The entrance slit 114 may be formed within the material 116. The entrance slit 114 may take forms such as circular, rectangular, or an elongated slot, but other examples are possible. The material 116 may include any material that is opaque to x-rays at suitable thicknesses, such as lead, tungsten, molybdenum, or steel. The entrance slit 114/material 116 may be fixedly coupled to the x-ray source 110 (e.g., via the structural element 118) such that the entrance slit 114 defines a range of angles δθ_{B} at which the x-rays 120 that are emitted by the sample 108 and pass through the entrance slit 114 are incident on the crystal analyzer 102.

The structural element 118 may include any rigid element (e.g., metal) that provides a common anchor point for both the material 116 (i.e., the entrance slit 114), the sample stage 106, and the x-ray source 110. For various reasons, it may be useful to maintain a constant spatial relationship between the x-ray source 110 and the entrance slit 114 as various samples are added and removed from the sample stage 106 for analysis. The structural element 118 may constitute a direct or indirect mechanical coupling between the material 116/entrance slit 114 and the x-ray source 110.

The detector 124 may take the form of any camera, line detector, or point detector configured to detect counts, intensity, and/or energy/wavelength of the x-rays 122 that are scattered by the crystal analyzer 102. In some examples, it may be cost-effective to use a position-insensitive x-ray detector, that is, an x-ray detector that counts x-rays received without regard to the position or angle at which such x-rays are received. The detector 124 may also include a mechanism (e.g., one or more motorized or non-motorized micrometers) configured to move the detector 124 relative to the crystal analyzer 102.

The x-rays 122 may include x-rays that are selectively scattered by the crystal analyzer 102 via Bragg scattering. That is, the x-rays 122 may be limited to an energy range that satisfies the Bragg condition of the crystal analyzer 102 and the angles δθ_{B} at which the x-rays 120 are incident on the crystal analyzer 102.

The spectrometer 100 may further include an optional exit slit 128 formed from x-ray opaque material 126. The purpose of the exit slit 128 may be to decrease stray scatter or other undesirable background from reaching the detector 124. The exit slit 128 will generally not interfere, constrain, limit the x-rays 122 from reaching the detector 124.

In some examples, an exit window 111 of the x-ray source 110 may be positioned 2-10 millimeters from the sample stage 106.

In some examples, a ratio of (a) a width of the entrance slit 114 within a plane of the Rowland circle 104 to (b) the radius of curvature of the crystal analyzer 102 is within a range of 0.0005 to 0.003.

In some examples, a ratio of (a) a distance of the sample stage 106 from the entrance slit 114 to (b) the radius of curvature of the crystal analyzer 102 is within a range of 0.002 to 0.01.

In some examples, the sample stage 106 is configured to support the sample 108 such that a line that bisects the entrance slit 114 forms, with a surface of the sample 108, an angle φ within a range of 10 to 45 degrees.

In some examples, the spectrometer 100 is operable to detect x-rays 122 with an energy resolution defined by a width of the entrance slit 114 within a plane of the Rowland circle 104 and with an energy reproducibility error defined by the position of the entrance slit 114.

In some examples, the spectrometer 100 is operable to detect x-rays 122 such that a ratio of (a) an energy reproducibility error to (b) actual energy of the x-rays 122 is at least as small as 7×10⁻⁵.

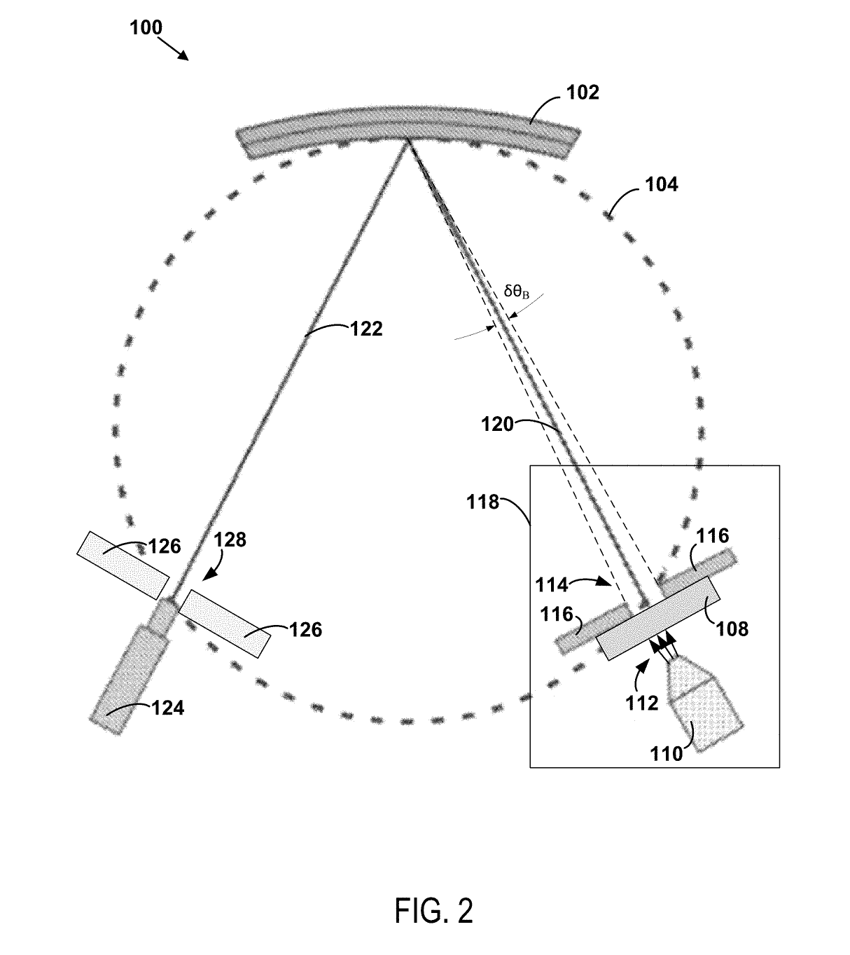

FIG. 2 depicts the spectrometer 100 in a different configuration, i.e., a transmission configuration.

Here, the sample 108 is mounted to the bottom of the material 116 and covers the entrance slit 114. The x-rays 112 are emitted by the x-ray source 110 toward the sample 108 and the entrance slit 114. The x-rays 120 in FIG. 2 represent x-rays that are transmitted by the sample 108 and through the entrance slit 114. The entrance slit 114 functions similarly to the scenario discussed above with respect to FIG. 1.

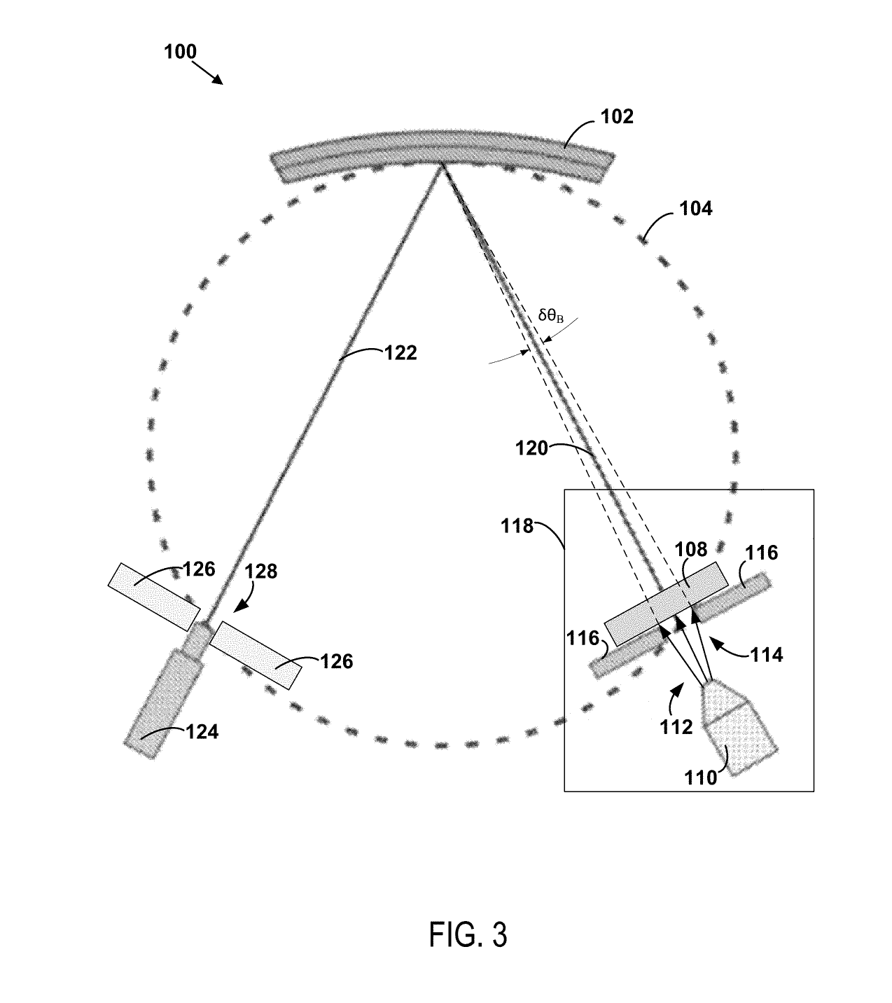

FIG. 3 depicts the spectrometer 100 in yet another transmission configuration. In contrast to FIG. 2, the sample 108 is mounted on top of the material 116. The entrance slit 114 functions similarly to the scenarios discussed above with respect to FIGS. 1 and 2.

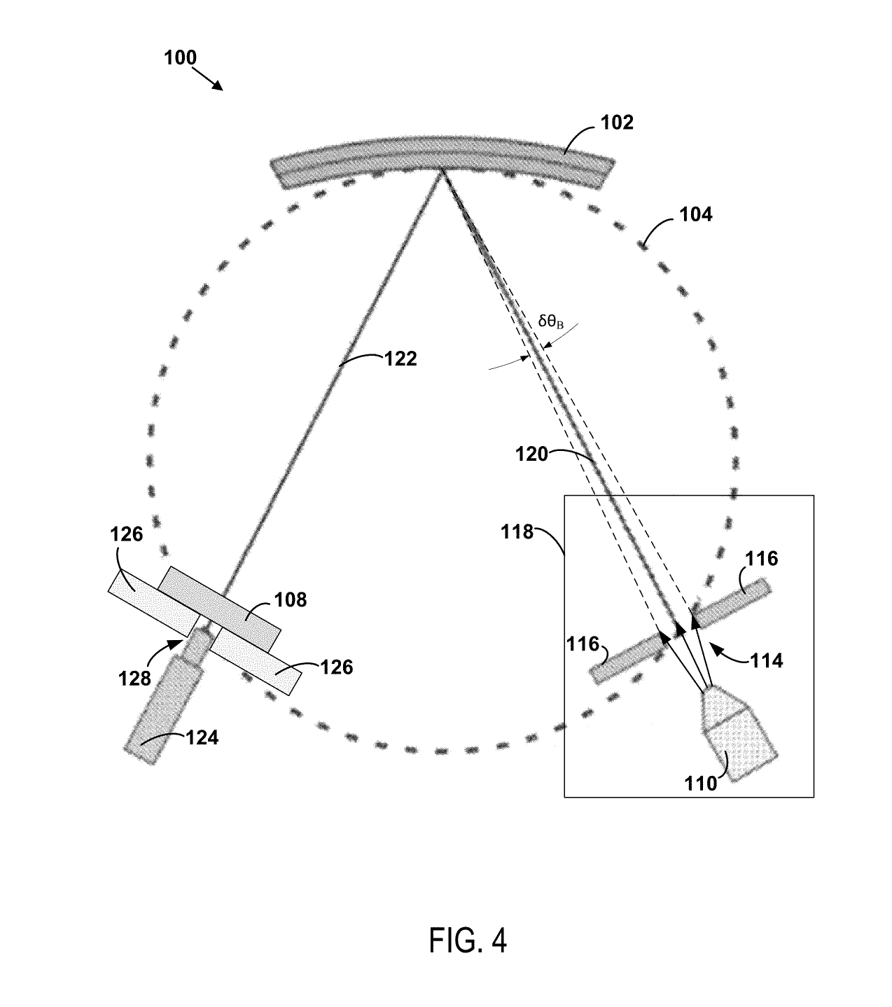

FIG. 4 depicts the spectrometer 100 in yet another transmission configuration. In FIG. 4, the sample 108 is mounted on top of the material 126 (i.e., the exit slit 128). The entrance slit 114 may define a range of angles δθ_{B} at which the x-rays 120 are incident on the crystal analyzer 102. The exit slit 128 may define a range of angles at which the x-rays 122 that transmit through the sample 108 are received by the detector 124.

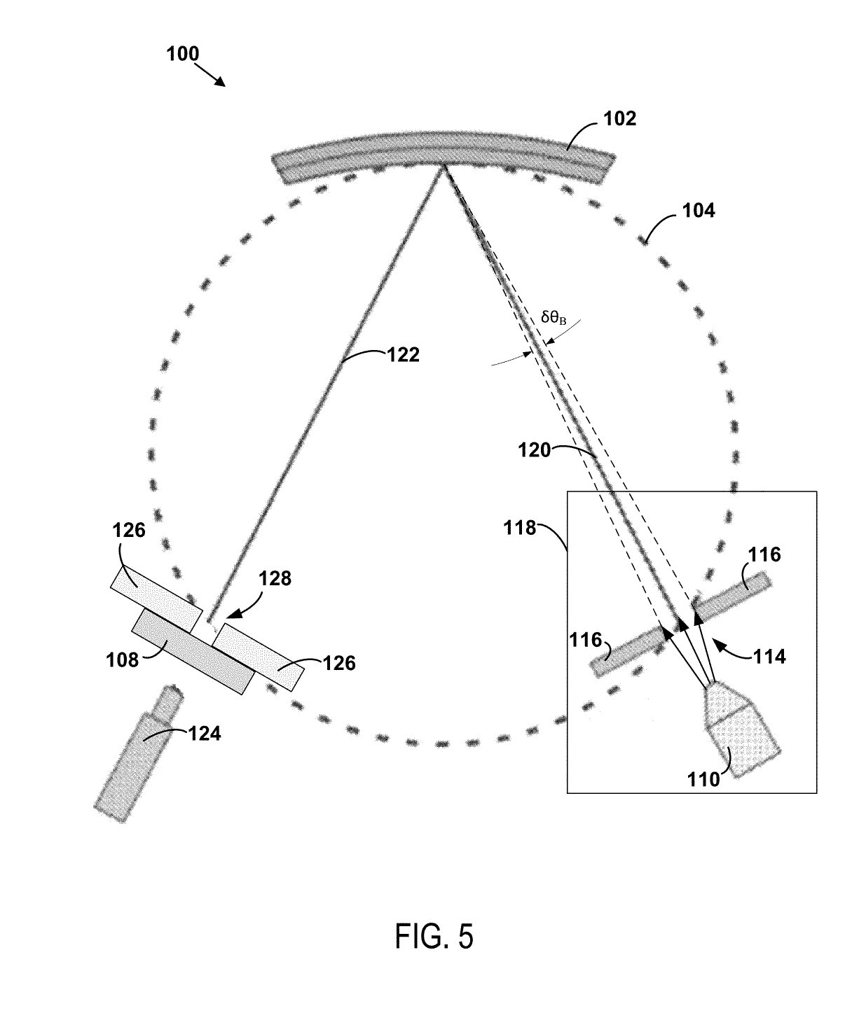

FIG. 5 depicts the spectrometer 100 in yet another transmission configuration. In FIG. 5, the sample 108 is mounted below the material 126 (i.e., the exit slit 128). The entrance slit 114 may define a range of angles δθ_{B} at which the x-rays 120 are incident on the crystal analyzer 102. The exit slit 128 may define a range of angles at which the x-rays 122 that transmit through the sample 108 are received by the detector 124.

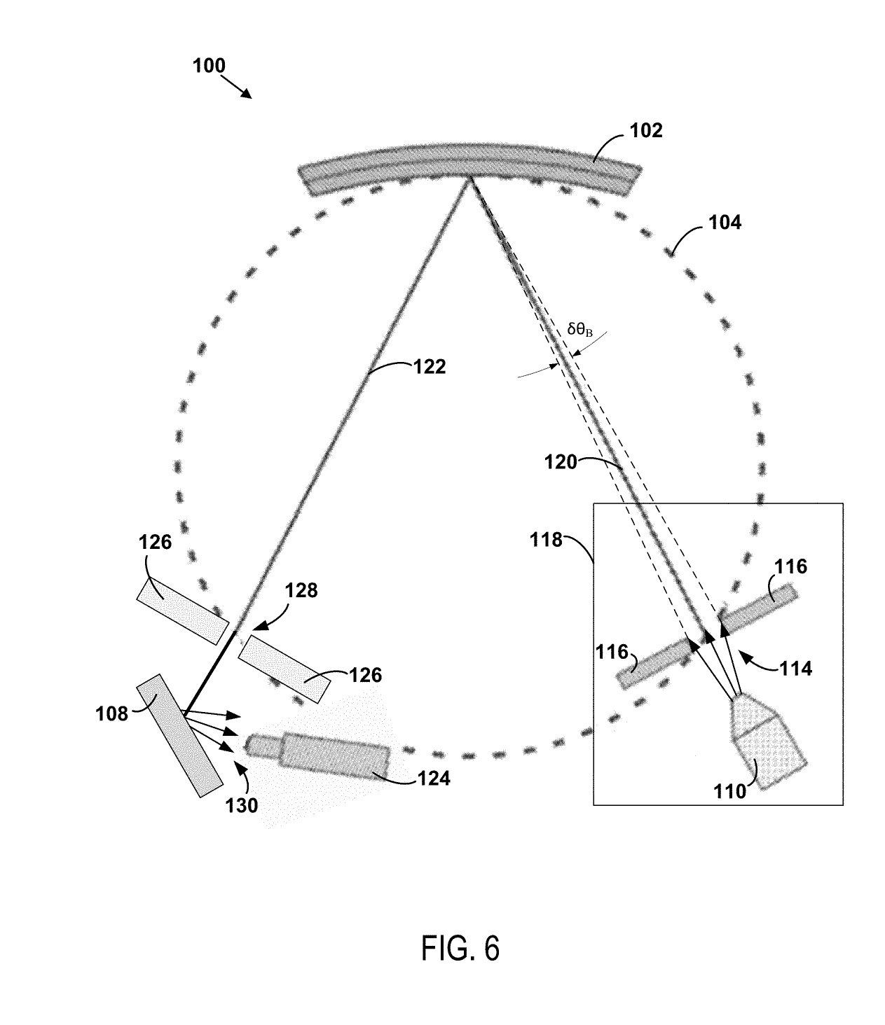

FIG. 6 depicts the spectrometer 100 in a florescence configuration, in which x-ray absorption is indirectly measured by detection of the fluorescence stimulated by monochromatized radiation incident on the sample 108 placed near the detector 124 that measures the florescent radiation.

In FIG. 6, the sample 108 is separated from the exit slit 128 and is positioned below the exit slit 128 to receive the x-rays 122 that are scattered by the crystal analyzer 102. The detector 124 may be aligned to detect the x-rays 130 that are emitted by the sample 108 after receiving the x-rays 122. It should be noted that the exit slit 128 is optional for any embodiments described herein.

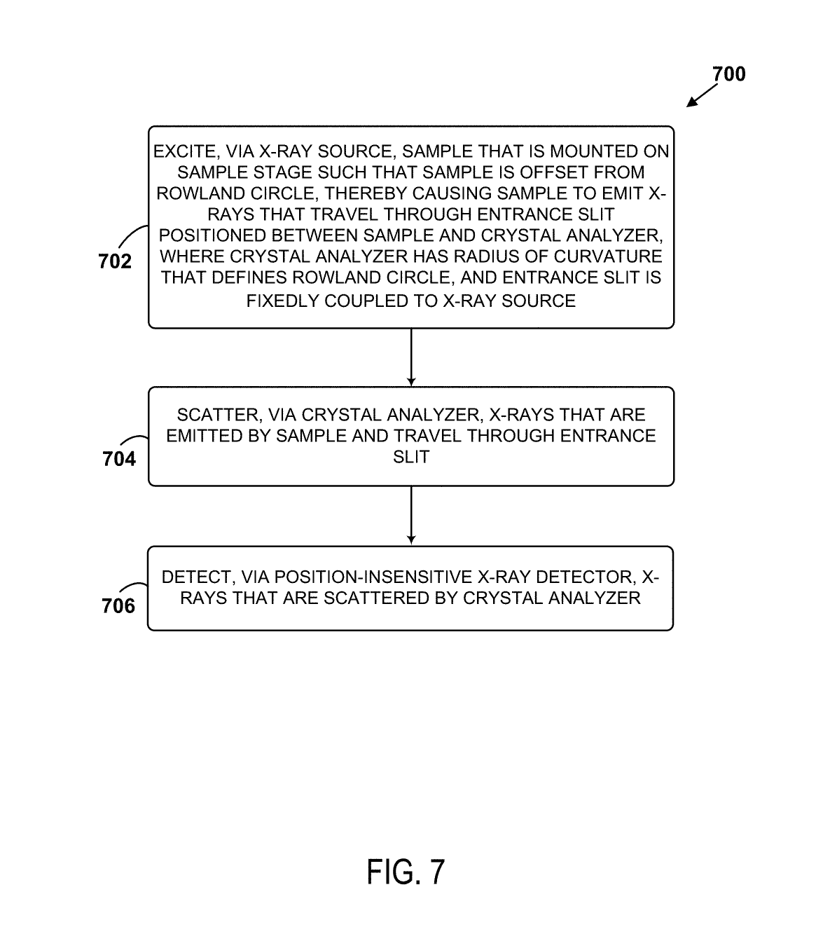

FIG. 7 is a block diagram of an example method 700 performed via a spectrometer having a Rowland circle geometry.

At block 702, the method 700 includes exciting, via an x-ray source, a sample that is mounted on a sample stage such that the sample is offset from the Rowland Circle, thereby causing the sample to emit x-rays that travel through an entrance slit positioned between the sample and a crystal analyzer. The crystal analyzer has a radius of curvature that defines the Rowland circle and the entrance slit is fixedly coupled to the x-ray source.

Referring to FIG. 1 for example, the x-ray source 110 may be used to excite the sample 108 that is mounted on the sample stage 106. In turn, the sample 108 may emit the x-rays 120 that travel through the entrance slit 114 that is positioned between the sample 108 and the crystal analyzer 102.

At block 704, the method 700 includes scattering, via the crystal analyzer, the x-rays that are emitted by the sample and travel through the entrance slit. For example, the crystal analyzer may scatter, via Bragg scattering, the x-rays 120 as the x-rays 122.

At block 706, the method 700 includes detecting, via a position-insensitive x-ray detector, the x-rays that are scattered by the crystal analyzer. For example, the detector 124 may detect the x-rays 122 that are scattered by the crystal analyzer 102.

In some examples, the detector 124 may be iteratively moved (e.g., aligned) along the Rowland circle 104 to increase or optimize the detected intensity of the x-rays 122.

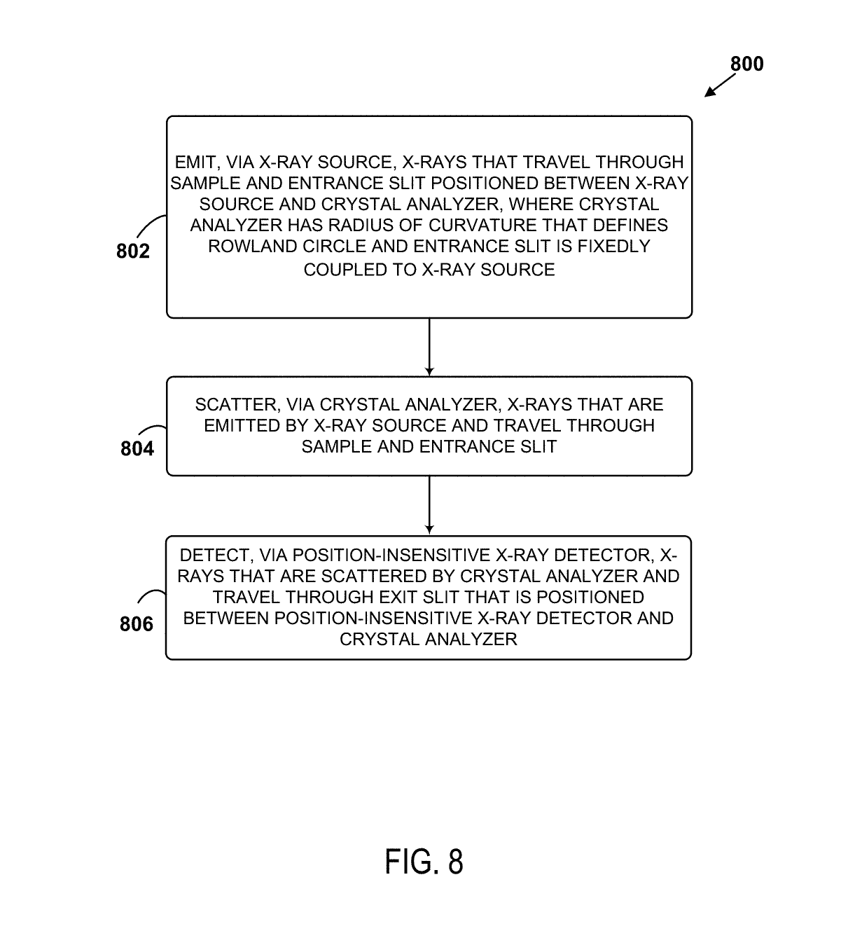

FIG. 8 is a block diagram of an example method 800 performed via a spectrometer having a Rowland circle geometry.

At block 802, the method 800 includes emitting, via an x-ray source, x-rays that travel through a sample and an entrance slit positioned between the x-ray source and a crystal analyzer. The crystal analyzer has a radius of curvature that defines the Rowland circle and the entrance slit is fixedly coupled to the x-ray source.

Referring to FIGS. 2 and 3, for example, the x-ray source 110 may emit the x-rays 112, some of which transmit through the sample 108 and the entrance slit 114 as the x-rays 120.

At block 804, the method 800 includes scattering, via the crystal analyzer, the x-rays that are emitted by the x-ray source and travel through the sample and the entrance slit.

Referring to FIGS. 2 and 3, for example, the crystal analyzer 102 may scatter the x-rays 120.

At block 806, the method 800 includes detecting, via a position-insensitive x-ray detector, the x-rays that are scattered by the crystal analyzer and optionally travel through an exit slit that is positioned between the position-insensitive x-ray detector and the crystal analyzer.

Referring to FIGS. 2 and 3, for example, the detector 124 may detect the x-rays 122 that optionally travel through the optional exit slit 128.

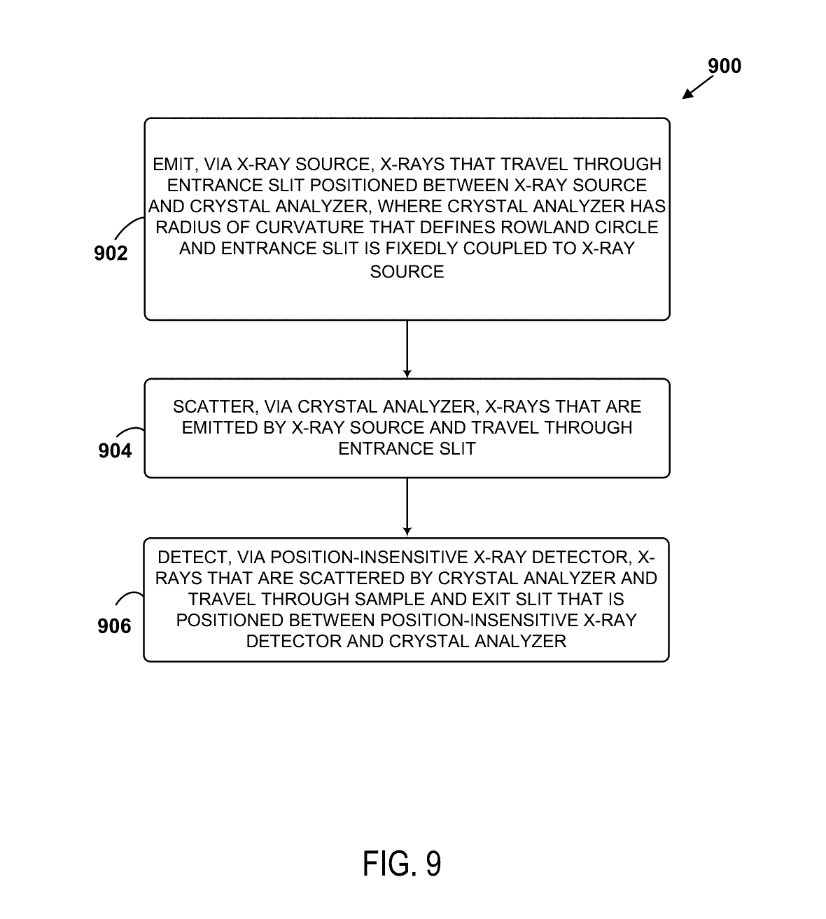

FIG. 9 is a block diagram of an example method 800 performed via a spectrometer having a Rowland circle geometry.

At block 902, the method 900 includes emitting, via an x-ray source, x-rays that travel through an entrance slit positioned between the x-ray source and a crystal analyzer. The crystal analyzer has a radius of curvature that defines the Rowland circle and the entrance slit is fixedly coupled to the x-ray source.

Referring to FIGS. 4 and 5, for example, the x-ray source 110 may emit the x-rays 120 that travel through the entrance slit 114.

At block 904, the method 900 includes scattering, via the crystal analyzer, the x-rays that are emitted by the x-ray source and travel through the entrance slit.

Referring to FIGS. 4 and 5, for example, the crystal analyzer 102 may scatter the x-rays 120 as the x-rays 122.

At block 906, the method 900 includes detecting, via a position-insensitive x-ray detector, the x-rays that are scattered by the crystal analyzer and travel through a sample and an exit slit that is positioned between the position-insensitive x-ray detector and the crystal analyzer.

Referring to FIGS. 4 and 5, for example, the detector 124 may detect the x-rays 122 that travel through the sample 108 and optionally through the optional exit slit 128.

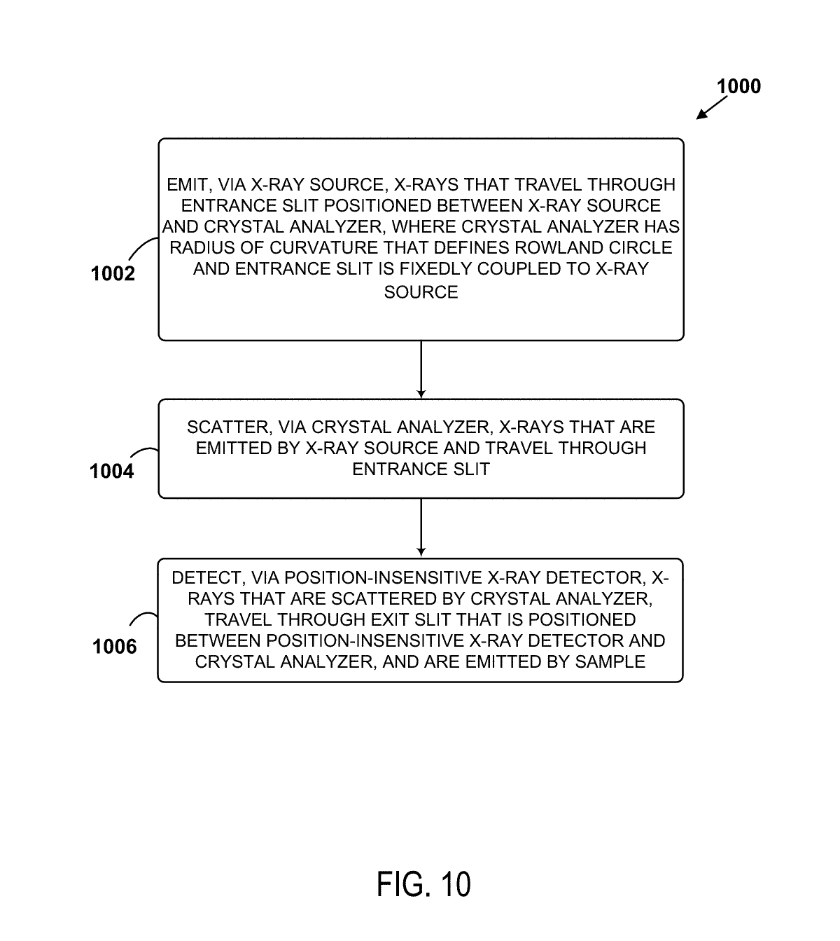

FIG. 10 is a block diagram of an example method 1000 performed via a spectrometer having a Rowland circle geometry.

At block 1002, the method 1000 includes emitting, via an x-ray source, x-rays that travel through an entrance slit positioned between the x-ray source and a crystal analyzer. The crystal analyzer has a radius of curvature that defines the Rowland circle and the entrance slit is fixedly coupled to the x-ray source.

Referring to FIG. 6 for example, the x-ray source 110 may emit the x-rays 120 that travel through the entrance slit 114.

At block 1004, the method 1000 includes scattering, via the crystal analyzer, the x-rays that are emitted by the x-ray source and travel through the entrance slit.

Referring to FIG. 6 for example, the crystal analyzer 102 may scatter the x-rays 120 as the x-rays 122.

At block 1006, the method 1000 includes detecting, via a position-insensitive x-ray detector, the x-rays that are scattered by the crystal analyzer, travel through an exit slit that is positioned between the position-insensitive x-ray detector and the crystal analyzer, and are emitted by a sample.

Referring to FIG. 6 for example, the x-rays 122 travel from the crystal analyzer 102 and through the optional exit slit 128 onto the sample 108. The sample 108 may emit the x-rays 130 in response to receiving the x-rays 122. The detector 124 may detect the x-rays 130.

The spectrometer 100 may be useful for performing measurements such as those described below. More specifically, the entrance slit 114 enables a very stable (i.e., reproducible) energy scale for comparing measurements of different samples. For example, it may often be useful to compare measurements of an unknown sample with measurements of a reference sample, or compare samples that were prepared, treated, or used differently. Whereas it may not be important to know the absolute energy value for a given energy peak in a given sample measurement, it may be more important to establish a reliable energy reference scale such that a small shift of that peak in a subsequent sample under test can be recognized. Such peak shifts may be indicative of changes or differences in material characteristics as described below.

In the technical art of this field of spectroscopy, the information that can be inferred from measurements made by the spectrometer 100 are known as “electronic structure” or “local electronic structure.” These terms refer to the total electronic properties of the excited elements, comprising but not limited to: nominal oxidation state of the excited element; nominal spin state of the excited element; the projection of occupied electronic states onto the excited element; and the projection of unoccupied electronic states onto the excited element. It is well known that the electronic structure is substantially dependent on the local coordination of atoms around the excited species.

For instance, the spectrometer 100 might be used in an absorption or transmission or fluorescence configuration for:
a. Determination of changes in oxidation state, local chemical coordination, or local atomic and electronic structure of metal species, such as Fe, in real or model soils as a function of independent control variables, such as microbial activity.
b. Determination of changes in oxidation state, local chemical coordination, or local atomic and electronic structure of metal species, such as Fe, in geological materials such as real or model soils, clays, basalts, and volcanic rocks when compared to known reference materials or as a function of independent control variables such as chemical treatment or geological history.
c. Determination of changes in oxidation state, local chemical coordination, or local atomic and electronic structure of transition metal species, such as Ni, Mn, Co, and Fe, in electrode materials for Li-ion batteries as compared to reference compounds.
d. Determination of changes in oxidation state, local chemical coordination, or local atomic and electronic structure of transition metal species, such as Ni, Mn, Co, and Fe, as a function of charge state in electrode materials for Li-ion batteries.
e. Determination of changes in oxidation state, local chemical coordination, or local atomic and electronic structure of metal species, such as Ni, Mn, Co, and Fe, as a function of preparation detail or usage fatigue in photocatalysts for solar energy harvesting.
f. High-precision comparison to reference compounds for determination of changes in oxidation state, local chemical coordination, or local atomic and electronic structure of transition metal species in metalorganic compounds and complexes, both as compared to reference compounds and as a function of external controls such as changing ligand species or optical photoexcitation.
g. High-precision comparison to reference compounds for determination of changes in oxidation state, local chemical coordination, or local atomic and electronic structure of metal species in catalysts used in refining in the fossil fuel industry, especially as a function of degradation during extended use. Specific metal species include Fe, Co, Mn, Mo, Rh, Pd, Au, and Pt.
h. High-precision comparison to reference compounds for determination of oxidation state of potentially toxic metals, such as Cr, As, Pb, Sr, and Ba, in mine tailings or related mining waste ponds, residues, or bioaccumulated animal tissue as compared to reference standards or as a function of site or weathering history, especially in the context of surveys for environmental monitoring or remediation under regulations in several jurisdictions.
i. High-precision comparison to reference compounds as a means to determine oxidation state of various elements, such as Br, Ba, Sr, Cr, As, Pb, in fluids or residues resulting from hydraulic fracturing extraction of fossil fuels.
j. High-precision comparison to reference compounds as a means to interpret spectral changes for lanthanide and actinide elements in separations chemistry processes or their resulting compounds, especially those used in processing of nuclear wastes or nuclear fuels.
k. High-precision comparison to reference compounds as a means to interpret spectral changes of lanthanide and actinide elements in mine tailings, mine waste ponds, or related residues.
l. High-precision comparison to reference compounds as a means to interpret changes in oxidation state, local electronic structure, and local coordination of metal species in glassy materials for use in long-term storage of nuclear waste.

For instance, the spectrometer 100 might be used in an emission configuration for:
a. Through precise comparison to experimental or theoretical reference standards, the determination of the fraction of Cr(VI) among all Cr contained in individual components of consumer products. This may be useful to test for compliance with reduction of hazardous substances regulations in several jurisdictions.
b. Through precise comparison to experimental or theoretical reference standards, the determination of the fraction of Cr(VI) among all Cr contained in samples of mine tailings, waste ponds, related residues, or animal tissue with bioaccumulated Cr, This may be useful for determination of environmental risk and/or compliance with regulation in several jurisdictions.
c. Through precise comparison to experimental or theoretical reference standards, the determination of the fraction of As(III) among all As contained in individual components of consumer products. This may be useful to test for compliance with reduction of hazardous substances regulations in several jurisdictions.
d. Through precise comparison to experimental or theoretical reference standards, the determination of the fraction of As(III) among all As contained in samples of mine tailings, waste ponds, related residues, or animal tissue with bioaccumulated As. This may be useful for determination of environmental risk and/or compliance with regulation in several jurisdictions.
e. Through precise comparison to experimental or theoretical reference standards, the determination of the oxidation state of toxic elements that can be found in mining waste ponds or in environmental areas contaminated by mining waste or in animal tissue with bioaccumulation of such elements, including As, Cr, Se, Sb, Zn, Hg, Cd, Bi, or Th.
f. Determination of changes in oxidation state or spin state of transition metal species, such as Ni, Mn, Co, and Fe, as a function of charge state in electrode materials for Li-ion batteries.
g. Determination of changes in oxidation state or spin state of transition metal species in metalorganic compounds and complexes, both as compared to reference compounds and as a function of external controls such as changing ligand species or optical photoexcitation.
h. Determination of changes in oxidation state or spin state of metal species in catalysts used in refining in the fossil fuel industry, especially as a function of degradation during extended use. Specific metal species include Fe, Co, Mn, Mo, Rh, Pd, Au, and Pt.
i. Comparison to experimental or theoretical reference compounds as a means for determining changes in oxidation state or spin state of lanthanide and actinide elements in separations chemistry processes or their resulting compounds, especially those used in processing of nuclear wastes or nuclear fuels.
j. Comparison to experimental or theoretical reference compounds as a means for determining changes in oxidation state or spin state of lanthanide and actinide elements in mine tailings, mine waste ponds, or related residues.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

What is claimed is:

1. A spectrometer comprising:
a crystal analyzer having a radius of curvature that defines a Rowland circle;
a sample stage configured to support a sample such that the sample is offset from the Rowland circle;
an x-ray source aligned to emit x-rays toward the sample;
an entrance slit formed within a material that is opaque to x-rays, wherein the entrance slit is fixedly coupled to the x-ray source such that the entrance slit defines a range of angles at which x-rays that are emitted by the sample and pass through the entrance slit are incident on the crystal analyzer; and
a position-insensitive x-ray detector aligned to detect x-rays that are scattered by the crystal analyzer.

2. The spectrometer of claim 1, wherein the crystal analyzer has a spherical curvature, a toroidal curvature, two or more curvatures, a curvature having a Johann variant, a curvature having a Johansson variant, or a cylindrical curvature.

3. The spectrometer of claim 1, wherein the radius of curvature of the crystal analyzer is twice as large as a radius of the Rowland circle.

4. The spectrometer of claim 1, wherein the sample stage is configured to support the sample such that the sample is outside of the Rowland circle.

5. The spectrometer of claim 1, wherein the x-ray source is configured to emit x-rays having a broadband energy spectrum.

6. The spectrometer of claim 1, wherein the x-ray source comprises an x-ray tube.

7. The spectrometer of claim 1, wherein the x-ray source is configured to emit unfocused x-rays.

8. The spectrometer of claim 1, wherein an exit window of the x-ray source is positioned 2-10 millimeters from the sample stage.

9. The spectrometer of claim 1, wherein a ratio of (a) a width of the entrance slit within a plane of the Rowland circle to (b) the radius of curvature is within a range of 0.0005 to 0.003.

10. The spectrometer of claim 1, wherein a ratio of (a) a distance of the sample stage from the entrance slit to (b) the radius of curvature is within a range of 0.002 to 0.01.

11. The spectrometer of claim 1, wherein the sample stage is configured to support the sample such that a line that bisects the entrance slit forms, with a surface of the sample, an angle within a range of 10 to 45 degrees.

12. The spectrometer of claim 1, wherein the spectrometer is operable to detect x-rays with an energy resolution defined by a width of the entrance slit within a plane of the Rowland circle and with an energy reproducibility error defined by the position of the entrance slit.

13. The spectrometer of claim 1, wherein the spectrometer is operable to detect x-rays such that a ratio of (a) an energy reproducibility error to (b) actual energy is at least as small as 7×10⁻⁵.

14. A spectrometer comprising:
a crystal analyzer having a radius of curvature that defines a Rowland circle;
an entrance slit formed within a material that is opaque to x-rays, wherein the entrance slit defines a range of angles at which x-rays that pass through the entrance slit are incident on the crystal analyzer;
an x-ray source aligned to emit x-rays toward the entrance slit, wherein the entrance slit is fixedly coupled to the x-ray source;
a position-insensitive x-ray detector aligned to detect x-rays that are scattered by the crystal analyzer; and
an exit slit formed within a material that is opaque to x-rays, wherein the material that forms the exit slit is configured to support a sample, wherein the exit slit defines a range of angles at which x-rays that are scattered by the crystal analyzer and transmitted through the sample are received by the position-insensitive x-ray detector.

15. The spectrometer of claim 14, wherein the x-ray source is configured to emit x-rays having a broadband energy spectrum.

16. The spectrometer of claim 14, wherein the x-ray source is configured to emit unfocused x-rays.

17. A method performed via a spectrometer having a Rowland circle geometry, the method comprising:
exciting, via an x-ray source, a sample that is mounted on a sample stage such that the sample is offset from the Rowland Circle, thereby causing the sample to emit x-rays that travel through an entrance slit positioned between the sample and a crystal analyzer, wherein the crystal analyzer has a radius of curvature that defines the Rowland circle, and wherein the entrance slit is fixedly coupled to the x-ray source;
scattering, via the crystal analyzer, the x-rays that are emitted by the sample and travel through the entrance slit; and
detecting, via a position-insensitive x-ray detector, the x-rays that are scattered by the crystal analyzer.

18. The method of claim 17, further comprising iteratively:
detecting an intensity of the x-rays that are scattered by the crystal analyzer; and
adjusting a position of the detector along the Rowland circle to increase the detected intensity of the x-rays that are scattered by the crystal analyzer.

19. The method of claim 17, wherein the sample is a first sample and the x-rays emitted by the first sample and scattered by the crystal analyzer are first x-rays, the method further comprising:
removing the first sample and mounting a second sample on the sample stage;
exciting the second sample, thereby causing the second sample to emit second x-rays that travel through the entrance slit;
scattering, via the crystal analyzer, the second x-rays;
detecting the second x-rays; and
determining an oxidation state of at least one chemical element in the second sample by comparing the first x-rays and the second x-rays.

20. The method of claim 17, wherein the sample is a first sample and the x-rays emitted by the first sample and scattered by the crystal analyzer are first x-rays, the method further comprising:
removing the first sample and mounting a second sample on the sample stage;
exciting the second sample, thereby causing the second sample to emit second x-rays that travel through the entrance slit;
scattering, via the crystal analyzer, the second x-rays;
detecting the second x-rays; and
determining an electronic spin state of at least one chemical element the second sample by comparing the first x-rays and the second x-rays.
